(19) United States
(12) Patent Application Publication
(10) Pub. No.: US 2005/0036457 A1
(43) Pub. Date: Feb. 17, 2005

(54) Messaging services offered in mobile communication systems

(75) Inventor: Hannu-Pekka Salin, Vantaa (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/683,399

(22) Filed: Oct. 14, 2003

(30) Foreign Application Priority Data
Aug. 14, 2003 (FI) 20031155

(51) Int. Cl. H04Q 7/00

(52) U.S. Cl. 370/328

(57) ABSTRACT

A method for rerouting messages in a mobile communications system allowing rerouting between different networks is described. The method—includes a step of setting in a first register node associated with a primary mobile number a request for forwarding messages addressed to the primary mobile number to a second mobile number. The method sends a message addressed to the primary mobile number from a messaging center to a gateway node and sends a request for routing information for the message from the gateway node to a first register node associated with the primary mobile number. Based on the request for forwarding messages, the method sends a request for routing information for the message from the first register node to a second register node associated with the second mobile number. The method sends a response including the routing information for the message to the gateway node.

### BACKGROUND OF THE INVENTION

1. Field of the invention

The invention relates to mobile communication systems, and more particularly to messaging services offered in mobile communication systems.

2. Description of the Related Art

The mobile communication systems allow mobility of users thereof. The mobile communication systems include various so-called cellular or otherwise wireless communication systems using radio frequencies for sending voice or data. The radio frequencies may be divided in channels including traffic channels for voice and data transfer and signal channels for transferring control signals for the purposes of setting up a call or controlling an ongoing connection. Examples of such mobile communication systems include standards such as the GSM (Global System for Mobile communication) or various GSM based systems, such as GPRS (General Packet Radio Service), third generation standards, such as the UMTS (Universal Mobile Telecommunication System).

In the mobile communication systems, it is possible to send messages, such as short messages (SM), without establishing a call connection between the sending party and the receiving party. The short message service (SMS) may utilize control channels of a communication system, such as a Stand-alone Dedicated Control Channel (SDCCH). It is therefore possible to send a short message even simultaneously with a voice or data call. The short messages may be first received by a mobile switching center (MSC) serving the sending party. The MSC serving the sending party may identify the number of the recipient and send the short message towards a short message service center (SMSC) associated with the receiving number. A SMSC may be connected with or included in a gateway node providing an interface between networks, such as a gateway mobile switching center (GMSC). The gateway node receives the short message via the SMSC and sends the short message to the receiving number. The gateway node may interrogate the home location register (HLR) associated with the receiving number to find out the current location of the mobile station. The gateway node then sends the short message towards the location the HLR has indicated via any associated mobile switching centers.

A short message service center is able to receive a short message through any network for a delivery to a mobile station (MS). A short message may come, for example, from another mobile station from the same or another network, through the public switched telephone network (PSTN), for example from a fax machine, or through a data communication network, for example from an Internet address.

It is known to reroute incoming calls to another number in the PSTN system and also in the mobile communications systems or even between those systems. When the subscriber requires calls coming to his primary number to be rerouted to a second number, he may activate call forwarding. Call forwarding may be unconditional so that a call is always transferred to the second number the subscriber has activated. It is also possible to set a conditional call forwarding so that a call is transferred to the second number if the primary number is occupied, does not respond or is not under radio coverage. In the GSM, call forwarding may be supported by the home location register (HLR) of the subscriber. The HLR stores the subscriber data and collects updated information of the subscriber's location. Call forwarding may be carried out by a mobile switching center (MSC) interrogating the called subscriber's HLR to determinate the location of the called mobile station. If the subscriber has activated the unconditional call forwarding function, the HLR returns the second number to the MSC. The MSC may then route the call to the second number. In the case the conditional call forwarding has been set, the HLR may first return the routing information for the primary number. If the primary number is busy or cannot be reached, the MSC may inform the HLR accordingly. The HLR may then respond by giving the routing information for the second number. In certain cases, it is also possible that the HLR indicates at once both alternatives, the primary number and the secondary number to be used in case a connection cannot be established with the primary number.

It is also known to send incoming short messages to another number inside a single network. In some mobile networks, an intelligent network (IN) based solution has been implemented. In that case, a Service Control Point (SCP) takes care of the rerouting of calls and even short messages. For the mobile originated short message service and mobile terminated short message service the SCP is situated in the voice mail service center (VSMC) in which the subscriber is roaming. This means that these services can only be used when the subscriber is roaming in the home mobile network. The SCP may take a duplicate of the message and send the duplicate to the second number. This results in additional traffic in the network.

Rerouting messages even between networks would be very useful for example in a situation where a subscriber has two different subscriptions. The subscriber might have one subscription for work and one for private use, from the same operator or from different operators. It might be advantageous to be able to reroute the messages destined to the work subscription number (work mobile) to the private subscription number (private mobile) independently of any call forwarding function. In certain cases, the subscriber may wish to set a condition that voice calls destined in the work mobile are not forwarded to the private mobile, but in the work mobile there is a voicemail available. If a voicemail is used, a short message indicating a received voicemail could be forwarded to the private mobile instead of the work mobile. Of course, the subscriber might have subscriptions from two operators for any other reason. The subscriber may wish to select that only messages are forwarded or that both messages and calls are forwarded.

Therefore, there is a need for a method for rerouting messages in a mobile communications system. In particular, it might be advantageous to be able to reroute messages addressed to a primary number of a subscriber to a second number even when the sender of the message is in a different network than the recipient and/or when the message is to be rerouted between different networks. It might be desirable to have the messages forwarded independently from call forwarding so that either of the actions can be activated separately or simultaneously. Furthermore, it might be desirable to be able to truly forward messages without producing duplicates of the messages.

### SUMMARY OF THE INVENTION

According to an embodiment of the invention, there is provided a method for rerouting messages in a mobile communication system. The method includes a step of setting in a first register node associated with a primary mobile number a request for forwarding messages addressed to the primary mobile number to a second mobile number. The method also includes a step of sending a message addressed to the primary mobile number from a messaging center to a gateway node. The method includes a step of sending a request for routing information for the message from the gateway node to the first register node associated with the primary mobile number. The method further includes the step of sending, based on the request for forwarding messages, a request for routing information for the message from the first register node to a second register node associated with the second mobile number. The method includes a step of sending a response including the routing information for the message to the gateway node. The method also includes the step of forwarding, based on the response, the message addressed to the primary mobile number to the second mobile number.

According to an embodiment of the invention, there is further provided a mobile communication system including a device for setting a request for forwarding messages addressed to a primary mobile number to a second mobile number. A messaging center is configured to receive a message addressed to the primary mobile number and to forward the message. A gateway node is configured to receive the message from the messaging center and to request for routing information for the message. A first register node associated with the primary mobile number is configured to obtain a request for forwarding messages addressed to the primary mobile number to the second mobile number. The gateway node is also configured to receive the request routing information for the message. Based on the request for forwarding messages, the gateway node is configured to request routing information for the message. A second register node associated with the second mobile number is configured to receive the request for routing information for the message and to provide a response including the routing information for the message. A device for sending sends the response including the routing information for the message to the gateway node. A device for forwarding, based on the response, forwards the message addressed to the primary mobile number to the second mobile number.

According to the invention, there is further provided a method for forwarding messages in a mobile communication system independently of calls carried by the system. The method includes the steps of creating, sending and determining. The step of creating creates a request for forwarding messages. The request includes a marker indicating that it relates to messages only. The step of sending sends a message addressed to a primary mobile number from a messaging center to a gateway node. The step of determining determines if the marker is set, and, if the marker is set, forwarding the message to a second mobile number.

### BRIEF DESCRIPTION OF THE DRAWINGS

The invention will now be described in further detail, by way of example only, with reference to the following examples and accompanying drawings, in which:

FIG. 1 shows an example of a mobile communication system in which the embodiments of the invention may be implemented.

FIG. 2 shows a short message forwarding procedure according to an embodiment of the invention;

FIG. 3 shows a short message forwarding procedure according to a further embodiment of the invention;

FIG. 4 shows a continuation procedure for the embodiment of FIG. 3;

FIG. 5 shows an alternative continuation procedure for the embodiment of FIG. 3;

FIG. 6 shows a signal chart for functionality in the first register node in accordance with an embodiment of the invention; and

FIG. 7 shows a flow diagram of a method according to an embodiment of the invention.

### DETAILED DESCRIPTION OF THE PREFERRED EMBODIMENTS

In connection with the invention, by the term “message” it is typically meant any message other than a voice call transferred in a mobile communication network. In particular, a message may be a message sent through a control channel in a mobile communication system without establishing a call connection between the sending and the receiving parties. Typically a message may be a mobile terminated short message (MT-SM), a multimedia message or any other message being sent without establishing a call connection between the sending and the receiving parties.

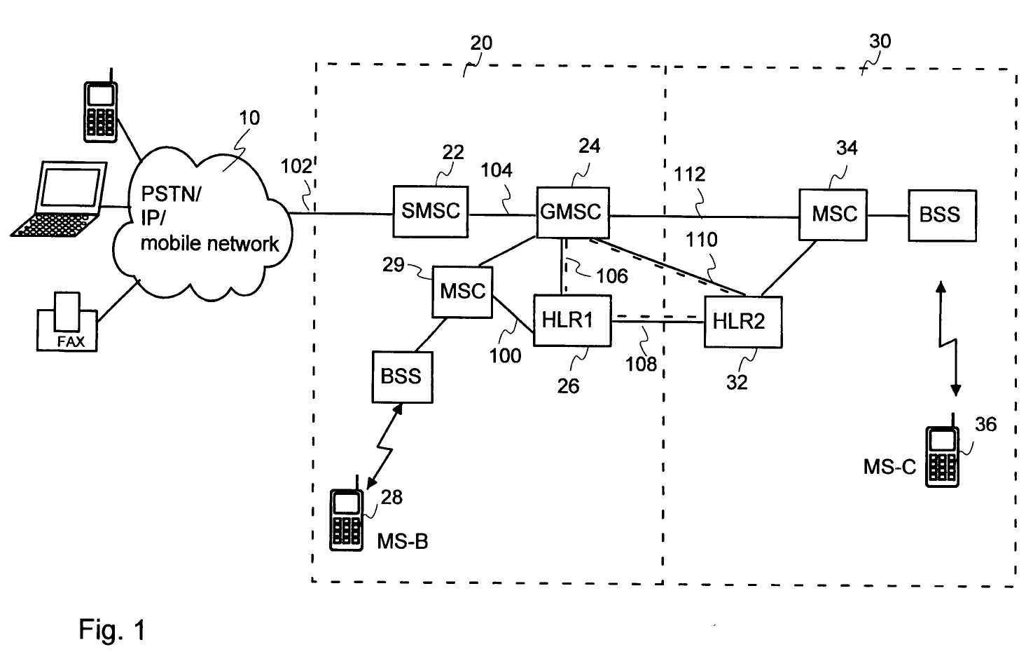

The example in FIG. 1 shows some of the elements of mobile communication networks 20 and 30. The network 20 is connected to a sending network 10. The sending network 10 may be any type of network having an interface with the network 20. Examples of possible networks 10 include, but are not limited to, PSTN, a data communication network provided by the Internet or a mobile network. Networks 10, 20 and 30 may also be one and the same mobile network.

In the mobile network 20, a messaging center 22, such as a short message service center (SMSC), receives messages, such as short messages, from the network 10. The messaging center 22 may be connected with or included in a gateway node 24, such as a gateway mobile switching center (GMSC), which serves as an interface to other networks, such as the networks 10 and 30. The connections to the network 20 from other networks, and from the network 20 to other networks, pass through the gateway node 24.

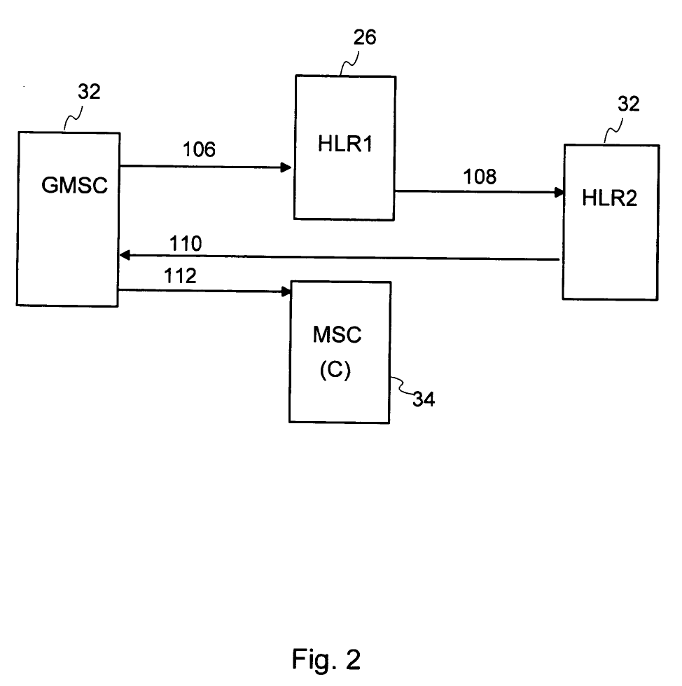

In FIGS. 1 and 2, an example of forwarding a message according to an embodiment of the invention is illustrated. In FIG. 1, the subscriber may set, in step 100, in the first register node 26 associated with a primary mobile number 28 a request for forwarding messages addressed to the primary mobile number 28 (mobile station B, MS-B) to a second mobile number 36 (mobile station C, MS-C). The second mobile number 36 may be either a subscription of the subscriber himself or any other mobile number capable of receiving the messages, such as short messages. The subscriber may use an appropriate user equipment, such as a mobile phone provided with a keyboard, to activate, deactivate and interrogate the status of the request for forwarding messages. The setting may also be done from another user equipment having an interface with the first register node 26, such as a personal computer having an Internet connection. The user equipment of the primary mobile number 28 and the first register node 26 may be connected via a serving node 29, such as a mobile switching center (MSC).

In step 102 in FIG. 1 the messaging center 22 may receive from the network 10 a message addressed to a primary mobile number 28 associated with the network 20. In step 104, the messaging center 22 may forward the received message to the gateway node 24 associated with the primary mobile number 28. The gateway node 24 may then, in step 106, send a request for routing information for the message to a first register node 26 associated with the primary mobile number 28, such as the home location register of the primary number (HLR1).

If a request for forwarding messages addressed to the primary mobile number 28 to a second mobile number 36 has been set in step 100, the first register node 26 may, in step 108, continue to request routing information for the message from a second register node 32 associated with the second mobile number 36, such as the home location register of the second number (HLR2). In step 110, the second register node 32 may then send a response back to the gateway node 24 indicating the routing information for the message to the second number 36. The response may be sent from the second register node 32 to the gateway node 24 either directly or through the first register node 26. For simplicity of presentation, only the direct sending is illustrated in the examples shown in FIGS. 1 and 2.

In step 112, the gateway node 24 forwards the message addressed to the primary mobile number 28 to a switch 34, such a mobile switching center (MSC), associated with the second mobile number 36. The switch 34 then sends the message to the second mobile number 36 in a known manner. If the second mobile number 36 is not in the area served by the register node 32, the location of the second mobile number 36 may be further requested from a visitor register node, such as a visitor location register (VLR) identified by the second register node 32.

For forwarding a short message, the messaging center 22 and the gateway node 24 need to know only the primary mobile number 28, even if message forwarding is required. It is the first register node 26 associated with the primary mobile number 28 which sends a further request for routing information to the second register node 32 associated with the second mobile number 36. The gateway node 24 may receive the routing information for the message including only the routing information for the second mobile number 36.

The gateway node 24, first register node 26 and the second register node 32 may communicate between each other through the signaling channels. The messages between the register nodes 26, 32 and the gateway node 24 may be sent using a so-called mobile application part (MAP) level signals used in the common channel signaling system No. 7 (SS7) provided by the International Telecommunication Union-Telecommunications Standardization Sector (ITU-T). The MAP level signal used to interrogate the HLR for routing information for a short message may be, for example, “send routing information for short message” (SRI-ForSM). The message may be sent to the switch 34 in a MAP level message “forward SM”. For other types of messages, MAP level messages may be formulated in a similar manner. Any other appropriate protocol may also be used in the method of the invention.

In an embodiment of the invention, the gateway node may set the primary mobile number as the called address. The network provides a request for routing information to the first register node associated with the primary mobile number. The gateway node sets its own address as the calling address so that the register node can respond to the gateway node in question. When the message forwarding has been set on, the first register node changes the second mobile number in place of the first mobile number. Then, the second register node may respond to the gateway node directly and there is no need to pass through the first register node.

In an alternative embodiment, the first register node may set its own address as the calling address. Then, the first register node may perform functions based on the response from the second register node. Such functions may include assigning to the subscriber information associated with the primary mobile number a service center (SC) address for a case when the second mobile number cannot be reached or any other functions related to message services.

In the embodiment of FIG. 2, examples of MAP level signals may be the following (signals in FIG. 2 are numbered with the procedure numerals defined above):
106: SRIForSM(CdPA=B-Msisdn, CgPA=GMSC-nbr, MAP level B-Msisdn) (send request information for short message, called party address is mobile subscriber integrated services digital network of B (i.e. the subscriber number of B), calling party address is GMSC);
108: SRIForSM(CdPA=C-Msisdn, CgPA=GMSC-nbr, MAP level C-Msisdn);
110: SRIForSM-Result(CdPA=GMSC-nbr, CgPA=HLR2-nbr, MAP level C-VMSC-nbr); and
112: Forward-SM(CdPA=C-VMSC-nbr, MAP level C-Mmsisdn).

In this example, if the second number is available, the message may be directly delivered to the mobile station associated with the second number 36. If the second number is not available, for example is not under radio coverage or there are other short messages delivered at the same time, the switch 34 may indicate the absence of the second number 36 to the gateway node 24. The message may then be left waiting in the messaging center 22 or in another appropriate node in the network. The gateway node 22 may indicate the absence of the second number to the first register node 26, which may forward the indication to the second register node 32. In the register nodes 26 and 32, an indication of a waiting message may be set in a “Message Waiting Data, (MWD)”-flag.

When the second number 36 becomes available in this example, the switch 34 may indicate the availability of the second number 36 to the second register node 32. The second register node 32 may indicate the availability of the second number 36 to the gateway node 24 through the first register node 26 or, in certain cases, directly.

In the second register node 32 in this example, there may be a counter registering each request for routing information from the second register node 32 and/or each forwarding of a message to the second mobile number 36. By using the information registered by the counter, it is possible to control the message forwarding for example by establishing loop preventions, or message forwarding override. For example, a situation where the message forwarding has been set from the primary number 28 to the second number 36 and at the same time from the second number 36 to the primary number 28 would result in an endless loop, if no loop prevention can be activated. If the counter indicates that forwarding messages happens too often, the second register node 32 might handle the message forwarding as inactive and forward no messages to the second number 36.

The counter might also be placed in the first register node 26 for counting the requests for routing information from the second register node 32. Loop prevention, or message forwarding override, may be activated, if requests for routing information are sent too often.

According to one embodiment, message forwarding override information may be added to the messages between the gateway node 24 and the register nodes 26, 32 also for other reasons. For example, the gateway node 24 may need the subscriber information associated with the primary number 28 and may request the subscriber information by sending a MAP level signal “SRIforSM”. If a message forwarding to the second number 36 is set in the first register node 26, the gateway node 24 normally receives the subscriber information of the second number 36. The register node 26 may be made to return the subscriber information of the primary number 28 by adding a message forwarding override indication to the message requesting the subscriber information of the primary number 28. This can be used accordingly in a case when the operator or any other entity wants to send a message to the primary number 26, but do not want this message to be forwarded even if the message forwarding was activated.

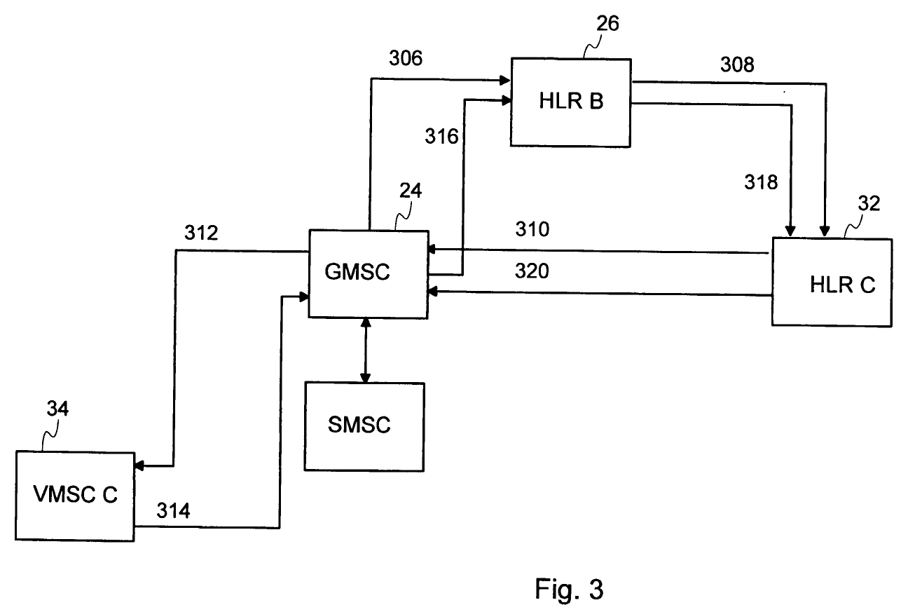

FIG. 3 shows an example of a signal chart for an embodiment of the invention. In the embodiment of FIG. 3, the gateway node 24 associated with a primary number sends to the first register node 26 a signal 306 requesting for routing information for a short message addressed to the primary number (number B). The signal 306 may be, if MAP level signals are used, for example, “SRIForSM CdPA=B-Msisdn, MAP level B-Msisdn”.

In this example, in the first register node 26, a message forwarding function has been set on. The first register node 26 sends a signal 308 requesting for routing information for a short message to be forwarded to a second number (number C). The signal 308 may be, for example, “SRIForSM CdPA=C-Msisdn, MAP level C-Msisdn, Extension=MF-counter.” In the exemplary signal 308, a message forward (MF) counter is activated.

The second register node 32 sends a response signal 310 to the gateway node 24 indicating the routing information, or the service center (SC), for the second number (number C). The signal 310 may be, for example, “SRIForSM Result CdPA=GMSC, CgPA=HLR C, MAP level VMSC-C Inform SC (C-Msisdn).”

The gateway node 24 sends, in a signal 312, the short message addressed to the primary number to a switch 34 serving the second number. The signal 312 may be “ForwardMT-SM (CdPA=VMSC, CgPA=GMSC).”

If the second number is available, the message is forwarded to it in a known manner (not shown).

If the second number cannot be reached, the switch 34 may send a signal 314 indicating the absence of the second number back to the gateway node 24. An example of the signal 314 may be “ForwardMT-SM Nack (CdPA=GMSC, CgPA=VMSC, Absent).” The gateway node 24 may then send a signal 316 reporting the status of the short message delivery to the first register node 26. An example of the signal 316 may be “SM-DeliveryStatus (CdPA=B-Msisdn, CgPA=GMSC, MAP level B-Msisdn).” The first register node 26 may set a “message waiting data” (MWD) flag and send a delivery status signal 318 to the second register node 32 and simultaneously the counter is again activated. An example of the signal 318 may be “SM-DeliveryStatus (CdPA=C-Msisdn, CgPA=GMSC, MAP level C-Msisdn; MF-counter)”. The second register node 32 may also set a “message waiting data” flag and acknowledge the delivery status, that is the absence of the second number, by sending a signal 320 to the gateway node 24. An example of the signal 320 may be “SM-DeliveryStatus Ack (CdPA=GMSC, CgPA=HLR C)”.

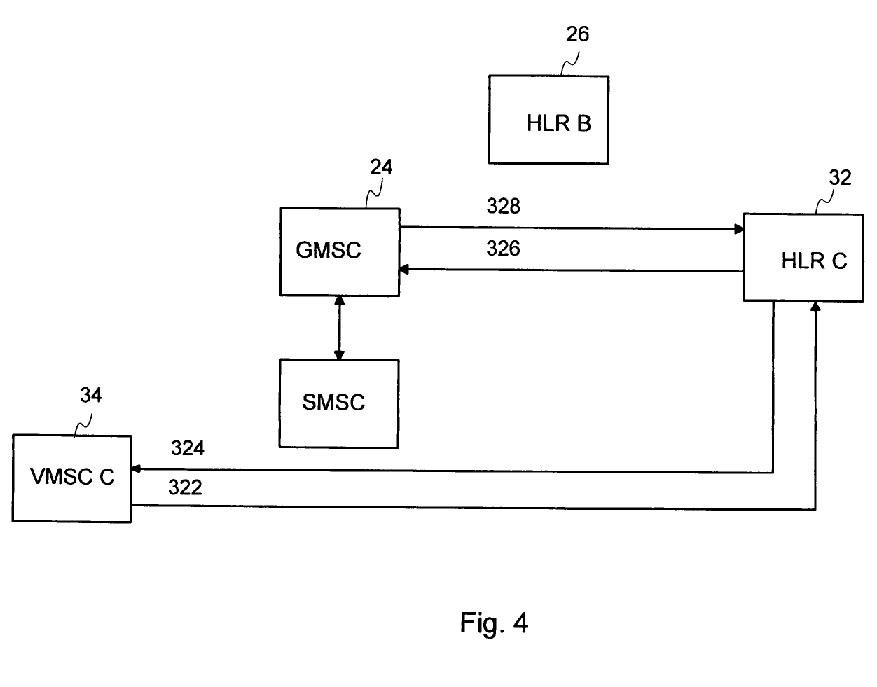

FIG. 4 shows an example of a signal chart for a continuation of the embodiment illustrated in FIG. 3. In this embodiment, the switch 34 notes that the second mobile number (number C) has become available, switch 34 may send a signal 322 to the second register node 32 indicating that the second mobile number is ready for receiving a message. The second register node 32 may acknowledge the indication in a signal 324 and send an alert signal 326 to the gateway node 24. The gateway node may then acknowledge the alert signal by a message 328 and start sending the short message in a similar way than in the embodiment of FIG. 3.

Examples of MAP level signals in FIG. 4 may include the following:
322: Ready For SM
324: Ready For SM Ack
326: Alert SC (C-Msisdn)
328: AlertSCAck

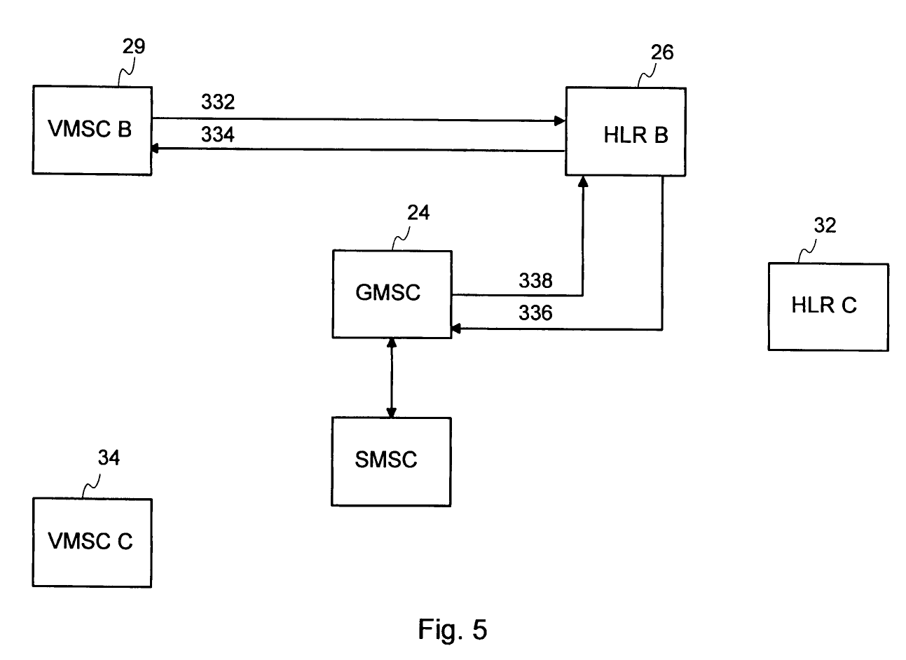

FIG. 5 shows an alternative example of a signal chart for a continuation of the embodiment illustrated in FIG. 3. In this embodiment, the subscriber of the primary mobile number may deactivate the message forwarding by sending an appropriate signal 332 via the serving node 29 to the first register node 26. The first register node may acknowledge the deactivation by signal 334 and send an alert signal 336 to the gateway node 24 indicating that the message, in this case the waiting message, should be sent to the primary number (number B). The gateway node acknowledges the alert in signal 338 and starts sending the message to the primary number.

Examples of MAP level signals in FIG. 5 may include the following:
332: Deactivate MFU for SMS; (MFU being message forwarding unconditional);
334: Deactivate MFU Ack;
336: Alert SC (B-MsisdnB);
338: AlertSCAck.

The deactivation may be done in a similar manner even if there was no “message waiting data” flag in the first register node. In that case, all the subsequent messages are sent directly to the primary number in a conventional manner.

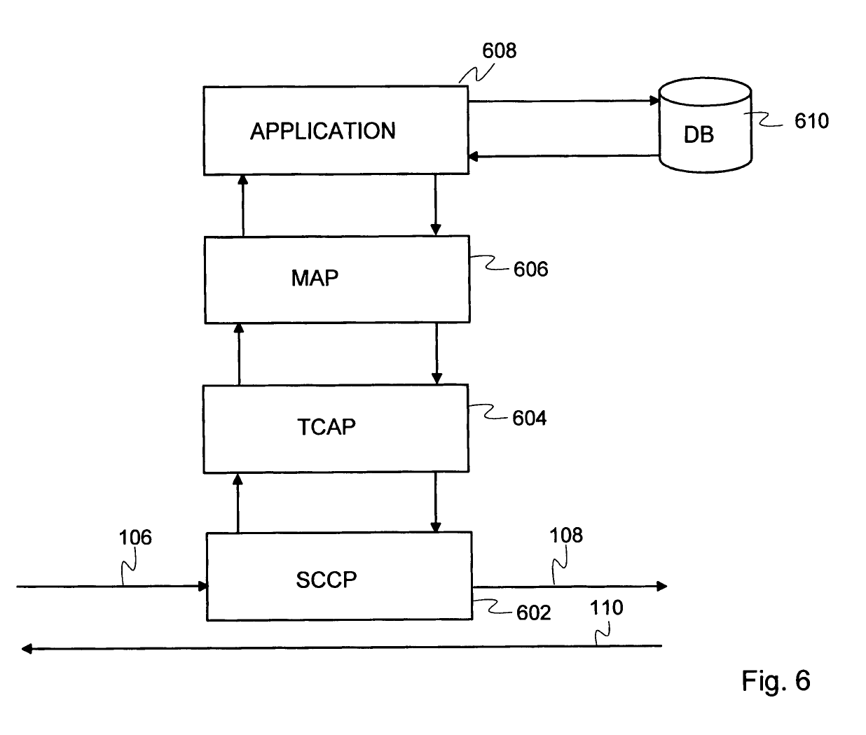

An example of a possible functionality in the register node in a case where the SS7 protocol is used is shown in FIG. 6. In FIG. 6, the signaling connection control part (SCCP) level 602 receives and sends the “SRIForSM”-signals. In the register node, the request passes from the SCCP level 602 through a transaction capabilities application part (TCAP) level 604 and through mobile application part (MAP) level 606 to an application part level 608. The application part level 608 makes a check from a database 610 of the register node storing the subscriber information. The result of the check may indicate that a function for forwarding messages is active. This result is sent back to the SCCP 602, which in turn formulates an appropriate message to be sent further as explained above.

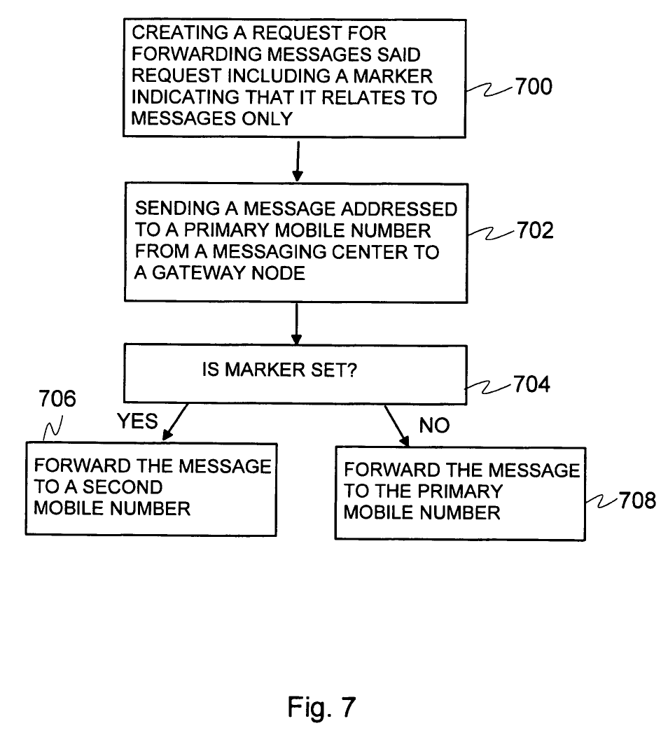

FIG. 7 shows an example of a flow diagram of a method for forwarding messages in a mobile communication system independently of calls carried by the system. In step 700, a request for forwarding messages is created. The request includes a marker indicating that it relates to messages only. As an example, this marker may be a numeral sequence included in a command similar to the known command for call forwarding in accordance with the GSM specification, but specifying that the marker is associated with message services. In the GSM specification, it has been defined that numeral sequence “16” indicates a short message service. Numeral sequence “21” is defined to indicate a supplementary service. An example for activation of short message forwarding may be **21C-number*16#, and accordingly for deactivation ##21**16# and for interrogating the status #21*16#. In step 702, a message addressed to a primary mobile number is sent from a messaging center to a gateway node. In step 704, it is determined if the marker is set. If the marker is set, the message is forwarded to a second mobile number, in step 706. If the marker is not set, the message is forwarded to the primary mobile number, in step 708.

Although the invention has been described in the context of particular embodiments, various modifications are possible without departing from the scope and spirit of the invention as defined by the appended claims. For example, instead of returning the routing information of the second number directly to the gateway node, the routing information may be returned to the first register node. The first register node may then act as a controller for sending the messages and for managing the waiting messages. In this manner, the activation and deactivation of the message forwarding may be taken into account without any delay. It may also be possible that the message forwarding is activated also from the second mobile number to a third number or even further. In such a case, the second and/or further register nodes act as the first register node described above. The register node associated with the final mobile number acts as the second register node described above. In other words, there may be one or more register nodes acting as the first register node described above.

1. A method for rerouting messages in a mobile communication system, the method comprising:
setting in a first register node associated with a primary mobile number a first request for forwarding messages addressed to the primary mobile number to a second mobile number;
sending a message addressed to the primary mobile number from a messaging center to a gateway node;
sending a second request for routing information for the message from the gateway node to the first register node associated with the primary mobile number;
sending, based on the first request for forwarding messages, a third request for routing information for the message from the first register node to a second register node associated with the second mobile number;
sending a response comprising the routing information for the message to the gateway node; and
forwarding, based on the response, the message addressed to the primary mobile number to the second mobile number.

2. The method according to claim 1, further comprising:
indicating an absence of the second mobile number to the gateway node when the second mobile number is not available for receiving the message.

3. The method according to claim 2, wherein the indicating step comprises indicating the absence of the second number directly from the second register node to the gateway node.

4. The method according to claim 2, wherein the indicating step comprises first indicating the absence of the second number from the second register node to the first register node and then sending the indication to the gateway node.

5. The method according to claim 1, further comprising:
creating a first request for forwarding messages said first request including a marker indicating that the request relates to messages only.

6. The method according to claim 1, further comprising:
rerouting messages independently of calls carried by a communications system.

7. The method according to claim 1, further comprising:
setting a counter for registering at least one of the following: at least one request for routing information from the second register node and at least one request for forwarding a message to the second mobile number.

8. The method according to claim 7, further comprising:
setting a message forwarding override based on the counter information.

9. The method according to claim 1, further comprising:
routing a message comprising at least one of the following: a short message service message and a multimedia message service message.

10. A mobile communication system comprising:
setting means for setting a request for forwarding messages addressed to a primary mobile number to a second mobile number;
a messaging center configured to receive a message addressed to the primary mobile number and to send the message further;
a gateway node configured to receive the message from the messaging center and to request routing information for the message;
a first register node associated with the primary mobile number configured to obtain a request for forwarding messages addressed to the primary mobile number to the second mobile number, to receive the request for routing information for the message and, based on the request for forwarding messages, to request the routing information for the message;
a second register node associated with the second mobile number configured to receive the request for routing information for the message and to provide a response comprising the routing information for the message;
sending means for sending the response comprising the routing information for the message to the gateway node; and
forwarding means for forwarding, based on the response, the message addressed to the primary mobile number to the second mobile number.

11. The mobile communication system according to claim 10, further comprising:
a counter for registering at least one of the following: at least one request for routing information from the second register node and at least one request for forwarding a message to the second mobile number.

12. The mobile communication system according to claim 10, wherein the message comprises one of the following: short message service message and multimedia message service message.

13. A method for forwarding messages in a mobile communication system independently of calls carried by the mobile communication system, the method comprising:
creating a request for forwarding messages said request including a marker indicating that the request relates to messages only;
sending a message addressed to a primary mobile number from a messaging center to a gateway node; and
determining if the marker is set, and, if the marker is set, forwarding the message to a second mobile number.
